(19) United States
(12) Patent Application Publication
(10) Pub. No.: US 2007/0146358 A1
(43) Pub. Date: Jun. 28, 2007

(54) Three-dimensional display

(75) Inventor: Willem L. Ijzerman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,884

(22) PCT Filed: Jan. 6, 2005
(86) PCT No.: PCT/IB05/50082

§ 371 Date: Jun. 28, 2006

(30) Foreign Application Priority Data
Jan. 9, 2004 (GB) 0400373.7

(51) Int. Cl. G06T 15/00; G09G 5/00

(52) U.S. Cl. 345/419; 345/6

(57) ABSTRACT

The invention relates to a three-dimensional auto-stereoscopic display aimed at, but not restricted to domestic television applications. In this display different viewing directions in the horizontal plane are created by projecting an image on a 2D display through lenticular lenses and onto horizontal lines of to the 3D screen. These lines are scanned along the display by means of a single rotating mirror. The proposed embodiment has a large viewing angle and shows a picture with realistic parallax and perspective. Compared to other known three-dimensional displays, it uses existing components, has a simple construction and is light efficient.

This invention relates to a three-dimensional (3D) autostereoscopic display and more specifically it relates to a 3D autostereoscopic display that can be used for domestic television applications.

The first generation of three dimensional television applications utilised stereoscopic displays showing two pictures uniquely observable by each of the viewer's eyes by using special glasses that selected the appropriate light for each eye. One approach was to have polarised glasses that only let through light of a specific polarisation. Another approach was to time-sequentially show the left and right eye images on a display and to use shutters for the eyes that only let in light when the appropriate image is shown on the display. However, using glasses are inconvenient and the lack of perspective results in discomfort among the viewers.

In autostereoscopic displays the images for the left and right hand eyes can be seen by the appropriate eyes without glasses since the light beams passing through the pixels containing information for the right eye is directed towards the right eye and the light beam passing through the pixels containing information for the left eye is directed towards the left eye. However, there is usually only a limited region wherein the viewer can see a 3D image since the eyes need to be in different regions of light. Increasing the number of views of an image source in the 3D picture results in a realistic sense of perspective since the viewer will see a new view of the image source every time he moves his head. Moreover, with a sufficiently large number of viewing directions, more than one viewer can watch the display simultaneously and see slightly different views of the object. However, to create a smooth transition between the views, a large number of views are needed and accordingly a very high-resolution screen is needed in order not to sacrifice the resolution of each individual view.

U.S. Pat. No. 5,969,850 (Sharp) discloses a display using a 2D display behind a barrier having vertical slots that can be made transparent. Every sub frame corresponds to a vertical line. When a new sub frame is shown on the 2D display a new vertical slot is simultaneously opened in the barrier. The light from the pixels making up the sub frame is transmitted through the vertical slot in different directions, one direction for each view and the number of horizontal pixels on the 2D display restricts the number of viewing directions. However, this display is very light inefficient since only a very small portion of the light emitted by the pixel actually reaches the observer. Consequently, for a television one needs a very bright light source to obtain a sufficiently light picture.

Another autostereoscopic display is disclosed in WO 98/34411 to Holografika wherein a number of 2D displays illuminated by laser diodes are used to produce the pixels for the 3D image and a special screen is used to increase the viewing angles. The number of 2D displays required for the 3D display is comparable to the number of views of the 3D image and separate projection optics is used for each 2D display resulting in an expensive 3D display.

The invention seeks to overcome these problems and improve on the existing products.

It is an object of the invention to provide an apparatus and a method for producing a 3D display which may be used in domestic television and video applications using a moving element and a light source of relative low light quality (large etendu).

According to the invention there is provided apparatus for providing a 3D image display comprising a frame of rows of pixels, the apparatus comprising at least one display unit including at least one row of display pixels each of which includes sub-pixels to display elemental regions of the image in different view directions, an optical lens arrangement configured to direct optical radiation from the different elemental regions into respective divergent beams corresponding to the view directions, a driver to drive the pixels of the display unit so as to display elemental regions of rows of the image successively, and an optical scanning system to receive the divergent beams from the lens arrangement for the rows successively and display them as rows of the image frame.

The display unit may be operated with a light source of relatively low quality (large etendu) and the light efficiency of the screen is high.

Furthermore, the display apparatus according to the invention may include a display screen, and the scanning device is operable to direct the beams corresponding to the successive rows of the image frame onto the screen. However the invention does not require the display screen to be configured to increase the viewing angle of the divergent beams in the horizontal direction. The appropriate directions and intensities of the light beams containing information for different viewing directions have already been determined before the light reaches the display screen. The screen may however include a vertical diffuser for spreading the beams in a direction transverse to the row direction.

The invention can be used in a domestic video application wherein the observers can move their eyes horizontally and vertically and still see a 3D picture.

Embodiments of the invention will now be described by way of example with reference to the accompanying drawings, in which:

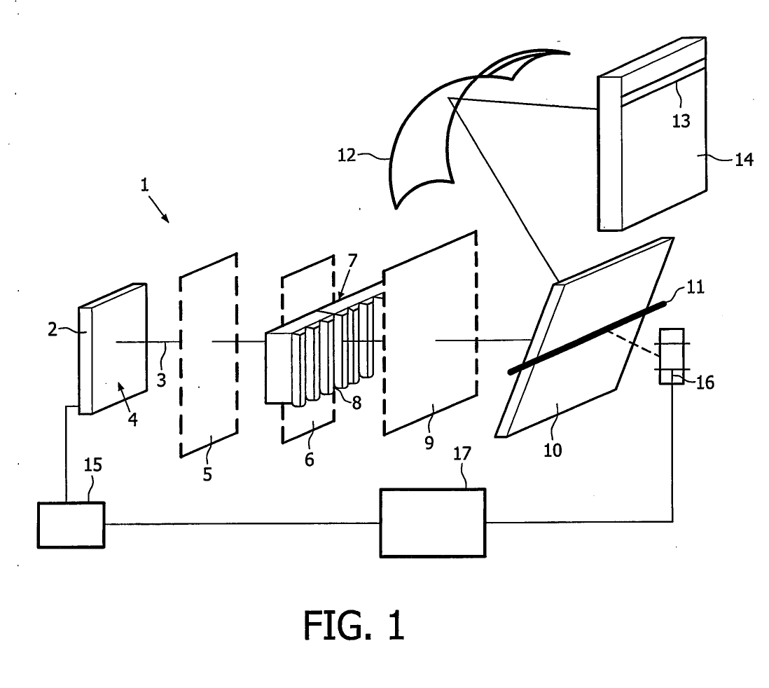

FIG. 1 is a perspective view of an apparatus according to the invention;

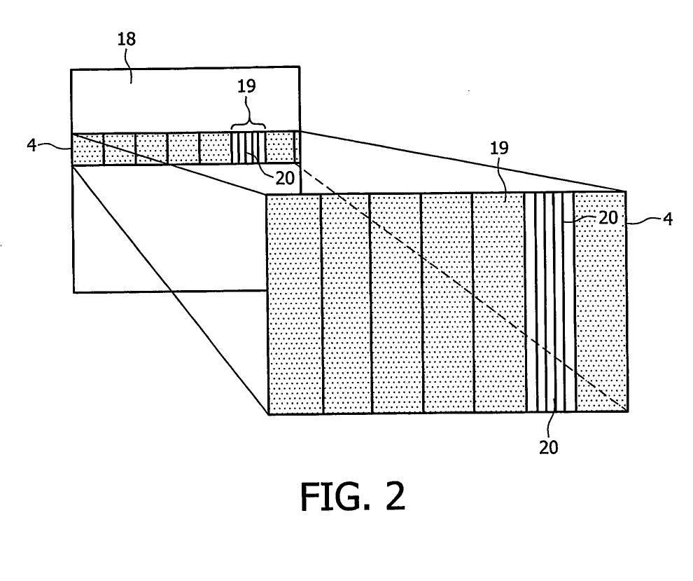

FIG. 2 illustrates schematically an example of arranging the pixels in order to produce a 3D picture;

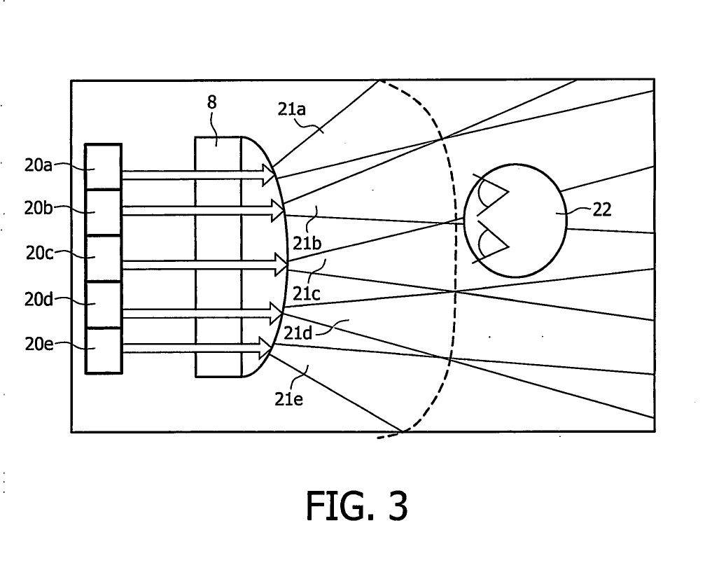

FIG. 3 illustrates schematically how the light is deflected from a lenticular lens in order to form a 3D picture;

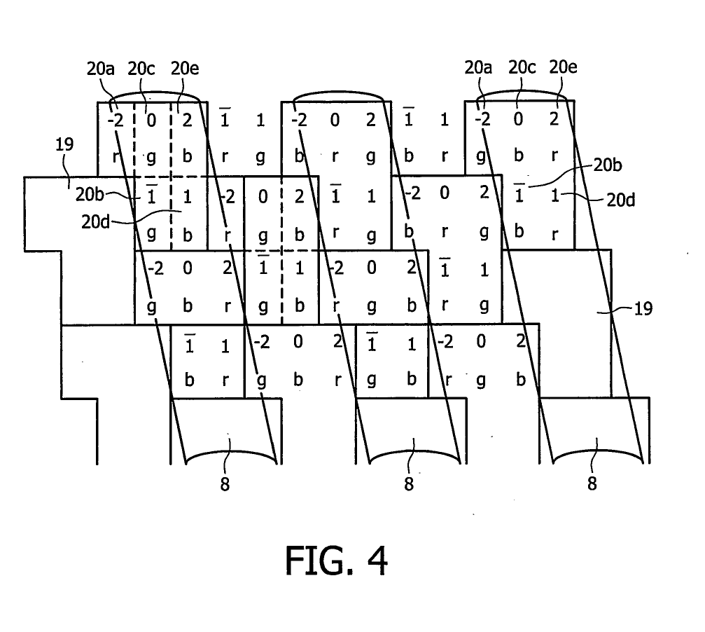

FIG. 4 is a partial view of the pixel structure used to create a 3D picture in another example;

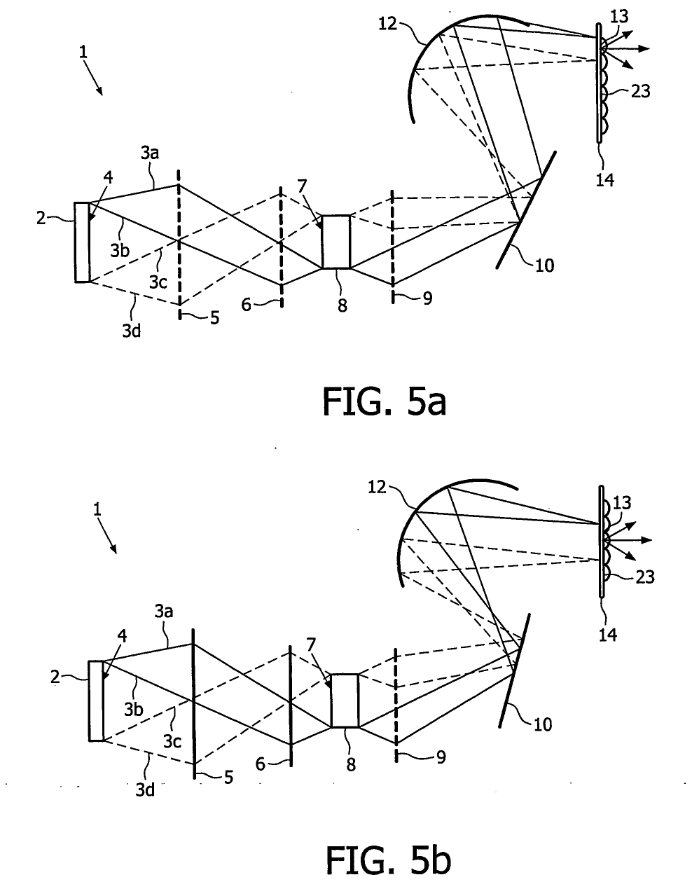

FIG. 5a and FIG. 5b illustrate the path of the light in the vertical direction for two positions of the rotating element;

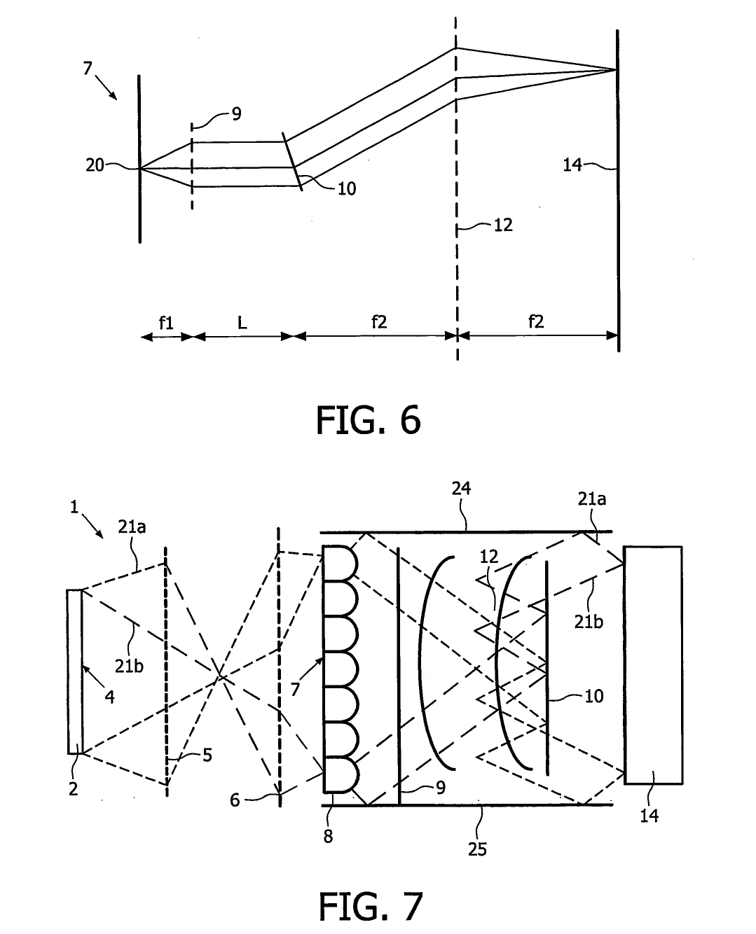

FIG. 6 illustrates the path of the light from an object point in the vertical direction;

FIG. 7 illustrates the path of the light in the horizontal direction;

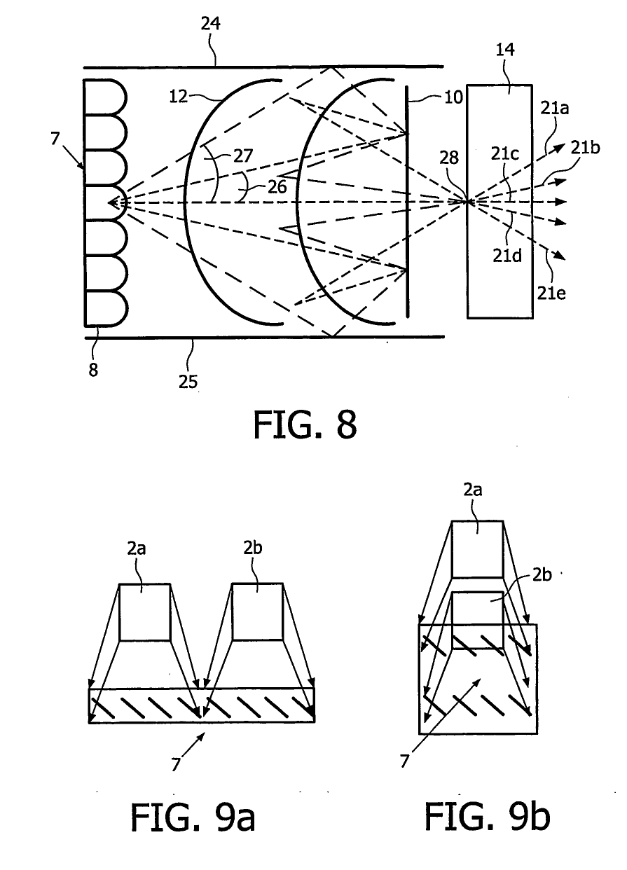

FIG. 8 illustrates in detail the horizontal path of the light rays emitted from the lenticular lenses;

FIGS. 9a and 9b schematically outline the use of two displays to increase the quality of the 3D image; and

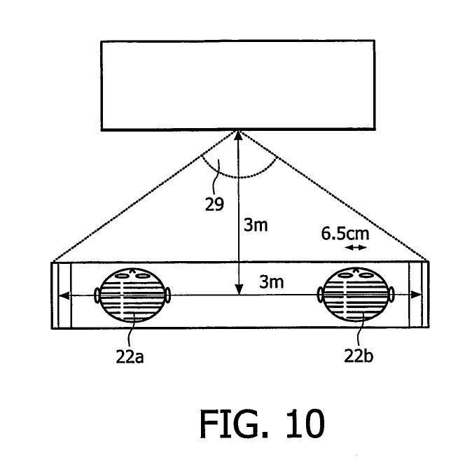

FIG. 10 is a schematic drawing of an environment in which the invention can be used.

FIG. 1 illustrates the set up of an apparatus 1 according to the present invention. The apparatus comprises a display unit 2 having a light modulator and a light source, for producing a beam 3 containing information corresponding to an array of pixels equivalent to one 2D frame 4 on the display. The apparatus further comprises two converging lenses 5, 6 that produce an intermediate image 7 of the 2D frame 4 focussed on columnar lenticular lenses 8. The purpose of the lenticular lenses is to deflect the light containing information for a particular eye in the direction of that eye such that the three dimensional effect is achieved. Furthermore the apparatus comprises a scanning system having a converging lens 9, a rotary mirror element 10, rotating around an axis 11, and a concave back mirror 12. The beams emitted from the lenticular lenses pass through the converging lens 9 and are reflected by the rotating element 10 onto the concave back mirror 12, which focuses the beams onto a horizontal line or row 13 of a display screen 14. The 3D image on the display screen 14 is formed of a frame of successive rows 13 produced from successive frames of 2D data displayed by the display unit 2, the rows 13 being displayed in a 3D frame on the screen 14 at spaced, parallel locations by means of the scanning system. If N rows 13 are required to form a 3D image in a particular time, then the display unit 2 has a 2D frame refresh rate of N times the 3D frame refresh rate. Alternatively, more than one display unit 2 can be used to reduce the 2D frame refresh rate required for the display unit 4, which will be further discussed below.

A display driver 15 is connected to the display unit 2 for driving the pixels of the display unit such that the 2D frame 4 displayed on the display unit 2 is refreshed, and a motor 16 for changing the tilt of the rotary mirror element 10. The display driver 15 and the motor 16 are further connected to a control unit 17 such that the display driver 15 and the motor 16 are synchronised. In this way, the display unit 4 displays successive 2D frames, and the mirror element 10 is successively tilted by an incremental angular amount between each 2D frame display, so as to provide successive rows of a frame of the 3D display at the screen 13. An example of a typical display unit 2 used is a dynamic micro-mirror device (DMD) available from Texas Instrument of Dallas, Tex., as part of their Digital Light Processing™ (DLP) solution. The DMD device includes a light source (not shown) which has its output modulated in a pixelated manner by the mirrors of the device.

FIG. 2 shows an example of the two-dimensional pixel structure of the 2D frame. Each 2D frame 4 is actually a horizontal slice of an overall image 18 that is to be displayed in 3D by the apparatus. Every 2D frame 4 of the original image 18 comprises one or more rows of pixels 19 each of which contain a number of subpixels 20 wherein each of the subpixels relate to different perspective views of the image source. Two consecutive views differ by an amount less than or equal to the amount required to account for parallax between the eyes. The subpixels 20 representing the separate views are interspersed in rows and columns in image 18. In the following examples the 3D picture contains five different views. However, it should be evident to the skilled reader that any number of views can be used and five views may not be enough to create a sufficiently large field of vision for a domestic television application. Consequently, a system using five views is used for illustration purposes only and in practice more views may be utilised.

FIG. 3 shows the purpose of the lenticular lenses. There is one micro-lens 8 for each pixel 19 such that the light from the separate subpixels 20 is transmitted in different directions. Each micro-lens produces cones of light comprising a plurality of angularly separated beams 21a-21e emitted at different angles. Two adjacent beams contain information corresponding to two adjacent elemental regions. When the viewer 22 has each eye in a respective one of two views separated by parallax, the viewer sees a 3D image. Moreover, as the viewer moves his head, the eyes will move into beams of light from different views such that the viewer gets a sense of perspective. It appears as if the viewer is looking at a 3D object through a window. In order to avoid discontinuous transitions between views, a larger number of views with smaller differences between the views can be used. In that scenario two consecutive views would be separated by less than the amount needed to account for parallax and consequently a smooth transition between views would be accomplished. Moreover, the angularly separated beams are emitted with different light intensities to further increase the sense that the viewer is looking through a window at a 3D object.

When the subpixels 17 of each pixel 16 are arranged side by side in a row, as in FIG. 2, the resolution in the horizontal direction is N times worse than in the vertical direction for an image containing N views. FIG. 4 illustrates a feature of the invention comprising an arrangement of subpixels and lenticular lenses that produces similar resolutions in the vertical and horizontal direction. The underlying idea for this arrangement is disclosed in U.S. Pat. No. 6,064,424 (Philips). Instead of arranging all subpixels in a row as in FIG. 2, the subpixels are arranged over two rows in FIG. 4. The number of the view refers to the position of the view. View 0 is the view seen by an observer looking at the image source straight on. Views 1 and −1 are the views seen when the observer moves a distance, d, equivalent to the separation required to account for parallax to the right and left respectively. Views −2 and 2 are the views seen when the observer moves a distance, 2*d, to the right or left respectively. Having vertically arranged lenticular lenses in front of this pixel structure would result in that the light transmitted through subpixel 2 and subpixel 1 would be deflected at the same angle. However, the light transmitted through subpixel 2 should be deflected at a larger angle than the light transmitted through subpixel 1. The lenticular lenses 8 are slanted to create the appropriate deflection angles. Consequently, an optional feature of the invention is to have slanted lenticular lenses.

The effect of the optical elements in the vertical and the horizontal direction will now be described in details with reference to FIG. 5 to FIG. 8. FIG. 5a and 5b illustrate how the light rays travel in the vertical direction. The rays 3a, 3b, 3c and 3d produced by the display unit 2 are focused by convex lens 5 and 6 onto the lenticular lens 8. The focal lengths of lens 5 and lens 6 are such that the size of the image frame 4 produced by display 2 is reduced in the vertical direction to the height of the projected row of the 3D image. Moreover, the intermediate image 7 is upside down. The lenticular lens 8 transmits the light without changing the vertical direction and a lens 9 is positioned such that its focal length is at the position of the lenticular lens. The light rays are consequently emitted parallel to each other from the lens 9 onto rotating element 10 that reflects the light onto the concave back mirror that focuses the beams onto a horizontal line. The screen 14 may be provided with a vertical diffuser in the plane of the rows to increase the viewing angle in the vertical direction such that the eyes of the observer 19 can be at varying heights but still see the same image. Accordingly, a whole family can view the image simultaneously even though the eyes of the parents are higher up than the eyes of the children. Horizontal cylinder lenses 23 that are smaller than the height of the individual rows 13 may be used for the vertical diffuser. For the rotary mirror element 10 a rotating plane mirror pivoting around an axis 11, parallel to the 3D projection screen, may be used. Alternatively a polygon with reflective sides can be used. In FIG. 5b the angle of the rotating mirror is altered as compared with FIG. 5a. The image frame 4 produced in FIG. 5b is projected onto a different horizontal line 13 of the screen 14 than the image frame 4 in 5a. Accordingly, as the tilt of the rotating mirror changes in correspondence with the rate of refreshing the image frame 4 displayed on the display 2, all the slices of the overall image 18 are projected onto the screen 14 to form a complete 3D picture. When all the frames 4 have been scanned and projected as a 3D picture the cycle starts all over again with a new image and the frame refresh rate is fast enough to create a moving 3D picture for the viewer.

FIG. 6 shows how the light from an image point of the intermediate image is focused on the screen and how the optical elements are arranged such that the focusing of the beam is not influenced by the rotary mirror element 10. The lens 9 is placed such that the intermediate image and the lenticular lenses 8 are at its focal point. The rotating mirror 10, on the other hand, is positioned in a plane corresponding to the focal point of the concave back mirror 12. This set up results in a parallel beam between lens 9 and concave back mirror 12. The distance from the concave back mirror 12 and the screen is also equal to the focus distance of the concave back mirror 12 taking care that one obtains an image on the screen. Consequently, the rotation of the mirror 10 does not perturb the focusing of the beam in the vertical direction on the screen 14.

FIG. 7 shows the path of the light in the horizontal direction. The lenses 5 and 6 have focal lengths in the horizontal direction such that an intermediate image is formed that has a horizontal width equivalent to the horizontal width of the projection screen. The intermediate image 7 is focused onto the lenticular lenses such that there is one lenticular lens for each pixel. The lenticular lens diverges the light rays and produces a cone of light, comprising one beam per subpixel. The light is directed through lens 9, which leaves the light unperturbed in the horizontal direction, and is reflected by the rotating mirror 10 onto the concave back mirror 12 that focuses the light onto the 3D screen 14. Additional side mirrors 24 and 25 are added to reflect diverging light back onto the screen. FIG. 8 shows in detail how the beams 21a-21e corresponding to the five different views emerge from the lenticular lens. The light representing the middle view 0, 21c, is not affected by the lenticular lens and continues straight through towards the screen. The beams corresponding to view 1 and −1, 21b and 21d respectively, are deflected at an angle 26, is reflected by the rotating mirror 10 and again by the concave back mirror before being focused on the screen 14. The light beams corresponding to pixel 2 and −2, beams 21a and 21e respectively, are deflected at an angle 27, is reflected by the side mirrors 24, 25 and the rotating mirror 10 before being finally reflected by the concave back mirror 12 and focused on the screen 14. At the screen 14 the rays corresponding to the different views are focused on the same point 28 but the rays have different directions and hence different views will be seen at different positions. The point 28 forms a 3D pixel, also called a voxel in the art, which emits light corresponding to different views of the same point of an image source in different directions.

Commercial DMD's typically have a frame refresh rate of 9700 frames per second and a resolution of 1024×768 pixels. Assuming 768 lines are required on the screen with a refresh rate of 50 Hz, a DMD with a frame refresh rate of 768*50=38400 Hz is needed which is four times the frame refresh rate of a typical DMD. Moreover, to create full colour and grey scale images the colour of the light emitted from the DMD needs to be varied time-sequentially, further increasing the required frame refresh rate of the DMD. An alternative method of producing full colour images is provided by the invention wherein colour and grey scale filters are placed at the position of the intermediate image 7 such that different colours can be produced by energising the appropriate pixels. For example, filters might be provided such that there is one colour filter for each column of lenticular lenses 8. Suitable arrangements of colour filters between the pixels and the lenticular lenses are further described in U.S. Pat. No. 6,064,424 (Philips). The advantage of this method is that the required frame refresh rate of the DMD is reduced. However, a disadvantage is that the spatial resolution of the screen is reduced further. If 24 rows of pixels are used to create the colours and grey scales there are 768/24=19 pixels in the vertical direction. Similarly, using 64 different views there are 1026/64=16 pixels in the horizontal direction. That results in an image frame 4 having 19*16=304 (RGB) pixels per view which does not provide a very good resolution. Either the number of rows on the screen needs to be dramatically increased, which means a refresh rate much larger than the refresh rate of a typical DMD, or more than one DMD is required. Consequently, a plurality of DMDs is used for producing a high quality moving 3D picture. FIG. 9a shows how two adjacent DMDs are used-to double the horizontal resolution. Similarly, FIG. 9b shows how two DMDs on top of each other are used to increase the number of scanned rows on the 3D screen without increasing the refresh rate of the DMDs. Each DMD scans half the height of the screen.

FIG. 10 schematically shows a typical arrangement of a room wherein the apparatus 1 for displaying a three dimensional image is used as part of a 3D domestic television and video kit. The screen is typically 3 m from the viewers and the viewing distance is approximately 3 m across. In order for everyone to see a three-dimensional image a viewing angle 29 of at least 2*tan⁻¹(1.5 m/3 m)˜60 degrees is required. The left and the right hand eye are positioned approximately 6.5 cm apart resulting in that at least 3 m/6.5 cm˜50 viewing directions are required. In order to avoid discontinuous transitions when moving one's head, at least 100 viewing directions are required.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. An apparatus (1) for providing a 3D image display comprising a frame of rows of pixels, comprising:
at least one display unit (2) including at least one row of display pixels (19) each of which includes sub-pixels (20) to display elemental regions of the image in different view directions,
an optical lens arrangement (8) configured to direct optical radiation from the different elemental regions into respective divergent beams (21a-21e) corresponding to the view directions,
a driver (15) to drive the pixels of the display unit so as to display elemental regions of rows of the image successively, and
an optical scanning system (9, 10, 12, 24, 25) to receive the divergent beams (21a-21e) from the lens arrangement for the rows successively and display them as rows (13) of the image frame.

2. The apparatus (1) according to claim 1 including a display screen (14), the scanning system (9, 10, 12, 24, 25) being operable to direct the beams corresponding to the successive rows (13) of the image frame onto the screen.

3. The apparatus (1) according to claim 2 wherein the screen (14) comprises a diffuser for spreading the beams in a direction transverse to the row direction.

4. The apparatus (1) according to claim 3 wherein the diffuser comprises lenticular lenses (23) generally parallel to the row direction.

5. The apparatus (1) according to claim 1 further comprising means (5,6) for focusing the elemental regions of rows of images onto the optical lens arrangement (8).

6. The apparatus (1) according to claim 5 wherein the means (5,6) for focusing the elemental regions of rows of images onto the lens arrangement comprises a plurality of converging lenses (5,6) with different focal lengths in the horizontal and vertical direction in order to match the dimensions of the elemental region of rows with the dimensions of the optical lens arrangement.

7. The apparatus (1) according to claim 1 wherein the optical lens arrangement comprise lenticular lenses (8).

8. The apparatus (1) according to claim 1 wherein the scanning device (9, 10, 12, 24, 25) comprises a rotary mirror element (10) to reflect the divergent beams (21a-21e).

9. The apparatus (1) according to claim 8 wherein the rotary mirror element (10) is a rotating mirror or a rotating polygon with reflective surfaces.

10. The apparatus (1) according to claim 8 wherein the scanning system (9,10,12, 24, 25) further comprises a concave mirror (12) to receive the divergent beams (21) from the rotary mirror element (10) and display them as rows (13) of the image frame.

11. The apparatus (1) according to claim 10 wherein the scanning system (9, 10, 12, 24, 25) comprises a lens (9) positioned in relation to the rotary mirror element (10) and the concave mirror (12) such that the rotary mirror element does not perturb the focusing of the image in the direction transverse to the row direction.

12. The apparatus (1) according to claim 10 wherein the scanning system (9, 10, 12, 24, 25) further comprises side mirrors (24, 25), and wherein the side mirrors and the concave mirror (12) are configured to focus the divergent beams (21a-21e) containing information from one pixel (19) onto a small area (28) of the rows (13) of the image frame.

13. The apparatus (1) of claim 1 wherein the pixels (19) contain enough subpixels (20) to provide enough elemental regions such that each of more than one observer (22a, 22b) can observe the 3D image simultaneously and each of the more than one observer sees a slightly different view.

14. The apparatus (1) of claim 1 wherein there are at least 50 elemental regions for each 3D image.

15. The apparatus (1) of claim 1 wherein for each elemental region there is another elemental region such that the images relating to the two elemental regions are shifted by less or equal to the parallax between the eyes.

16. The apparatus (1) of claim 1 wherein a plurality of display units (2) are placed adjacent to each other in the direction parallel to the row direction and wherein the driver is configured to display different information on each display such that all the information corresponding to one row of the 3D image is displayed simultaneously across the plurality of the display units (2).

17. The apparatus (1) of claim 1 wherein a plurality of display units (2) are placed adjacent to each other in the direction transverse to the row direction and wherein the driver is configured to display information on the plurality of displays relating to different rows of the 3D image frame and the scanning system comprises a plurality of rotary mirror elements for scanning the information onto said rows.

18. A domestic video and television display comprising the apparatus according to claim 1.

19. A method for providing a 3D image having a frame of rows of pixels, comprising:
providing successive displays (4) each including at least one row of display pixels (19) each of which includes sub-pixels (20) corresponding to elemental regions of the image in different view directions,
directing optical radiation from the different elemental regions into respective divergent beams (21) corresponding to the view directions, and
receiving the divergent beams (21) or the rows successively and displaying them as rows (13) of the 3D image frame.

20. The method of claim 19 further comprising spreading the light containing the divergent beams in a direction transverse to the row direction in order to enlarge the viewing angle in the direction transverse to the row direction.

21. The method of claim 19 further comprising displaying the 3D image on a display screen (14), and
separating the beams (21) from different elemental regions before they are displayed on the display screen (14).

22. The method of claim 19 comprising creating a 3D pixel (28) on the display screen (14) by directing all the separate beams corresponding to different subpixels (20) of the same pixel (19) onto the same small area (28) of the display screen (14), such that the 3D pixel emits light corresponding to different views of the same point of an image source in different directions.

23. The method of claim 19 when used for domestic television and video projection.
